(19) United States
(12) Patent Application Publication
(10) Pub. No.: US 2008/0053752 A1
(43) Pub. Date: Mar. 6, 2008

(54) System and method for securing a window in a panel

(76) Inventors: Peter Miller, Wauconda, IL (US); Duer Miller, Wauconda, IL (US)

Correspondence Address: THE ECLIPSE GROUP, 10605 BALBOA BLVD., SUITE 300, GRANADA HILLS, CA, 91344, US

(21) Appl. No.: 11/517,120

(22) Filed: Sep. 6, 2006

(51) Int. Cl. E06C 1/00

(52) U.S. Cl. 182/169

(57) ABSTRACT

A panel for use in a door having an access area that allows a window to slide into at least one channel formed in the sides of a window area within the panel.

### BACKGROUND OF THE INVENTION

1. Field of the Invention

This invention relates generally to panels with windows and more particularly to securing windows in panels, such as door panels.

2. Related Art

Often in retail stores, grocery stores and warehouses, interior doors are used to separate one area from another area of the building. Traditionally, these interior doors separate the public area of a store from the back area/stock area/load docks of the store. Unlike a normal interior door, these interior doors often have to be wide enough to move pallets and other large/bulk containers through (sometimes with the aid of a forklift or pallet-jack). Thus, the term traffic-door has been adopted to describe these types of interior doors.

The requirement for traffic-doors vary by size, material and application, but in general they are self-centering bi-directional doors that have a panel with a windows. The window in the panel of the traffic-door enables a person to see if the traffic-door may be safely open.

Typically the window in a traffic-door is secured or mounted to the door panel, either by gasketing or by mechanical fasteners. The gasketing approach to securing windows in the panels of traffic-doors has numerous known disadvantages relating to manufacturing and use. These disadvantages include being difficult to and labor intensive to install. In addition to be being labor intensive to install, the cost of gasketing material is relatively high compared to using mechanical fasteners. Another disadvantage to gasketing is the ability to dislodge the window and gasket when merchandise (such as pallets) strikes the traffic-door or when a person strikes the window.

The mechanical fasteners approach to securing windows in panels of traffic-doors also has numerous disadvantages. Mechanical fastens typically are used with frames to hold the window securely in traffic-doors and like gasketing, the mechanical fastener approach is labor intensive and requires additional parts and frames that must be made to predetermined tolerances. Since the frames often protrude from the traffic-door, merchandise catching on the frame or fasteners may be dislodged as it passes through the traffic-door creating a mess for people to clean up and limits the use of the door until cleared. Further, people may be hurt by the edges of the frame or protruding fasteners if they come in contact with the mechanical fasteners.

Therefore, there is a need for methods and systems for securing widows in doors, such as traffic-doors, that overcomes the disadvantages set forth above.

### SUMMARY

Merchandise moving through doors, such as traffic-doors, often makes contact with the panel surface of the traffic-door. A smooth, low friction panel, free of projections from the flat background of the panel is achieved by the system and method of the present invention.

Systems and methods consistent with the present invention provide an approach for fabricating a panel having a window that is secured by sliding the window in a channel that is formed around the window cutout area, where the window enters the channel in an access area of the panel. An adhesive may then be used in a portion of the access area or channel to further assist in securing the widow within the panel.

Other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates an oscillating self-centering traffic-door with a beam and a panel, where the panel has a window secured in accordance with an example implementation of the invention.

FIG. 2 illustrates a front view of the widow secured in the panel of the oscillating self-centering traffic door of FIG. 1.

FIG. 3 illustrates of a cross sectional view of the panel of FIG. 1 along the x-axis.

FIG. 4 illustrates of a cross sectional view of the panel of FIG. 1 along the y-axis.

FIG. 5 illustrates the approach to securing a window in the panel of FIG. 1 with channels formed around the perimeter of the window opening.

FIG. 6 illustrates another approach to securing a window in the panel of the oscillating self-centering traffic-door.

FIG. 7 illustrates a flow diagram of the steps for securing a window in a panel of the self-centering traffic-door of FIG. 1.

### DETAILED DESCRIPTION

Unlike the known approaches previously discussed, an oscillating self-centering traffic-door with a beam and a panel that secures a window that overcomes the above limitations is described.

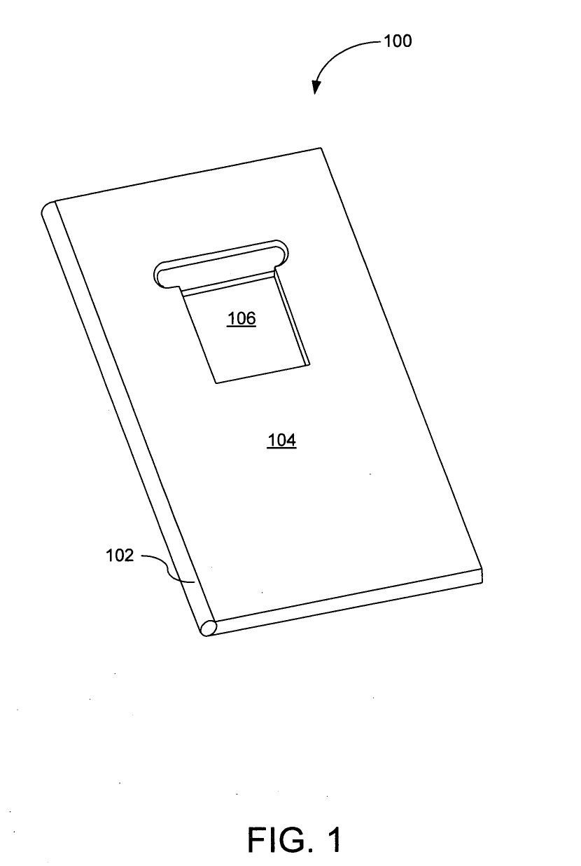

Turning first to FIG. 1, an illustration of an oscillating self-centering traffic-door 100 with a beam 102 and a panel 104, where the panel 104 has a window 106 secured in accordance with an example implementation of the invention is depicted. The panel 104 may be composed of any type of material that can be worked by a milling machine or molded, for example wood, metal, plastic, paperboard, fiberglass or a combination of wood, metal, plastic, paperboard and fiberglass, to give but a few examples.

The panel 104 illustrated in FIG. 1 may be a molded door panel of KEVLON, a thermosetting, polymetric encapsolent, formed around a closed-cell insulator resistant to moisture, retaining its initial insulator properties even following prolonged exposure to water leakage, humidity, condensation and freeze-thaw cycling. But, in other implementations, other types of materials and polymers may be used for or in panel 104, such as high-density polyethylene.

The window 106 may be made out of any transparent or semi-transparent material that is able to be flexed enough to fit into the panel 104 in the current illustration of FIG. 1. Examples of such materials include Plexiglas, acrylic thermoplastic, ULTRADUR™, thermoplastic polyester, GEON™, A thermoplastic vinyl-chloride, LEXAN™ a polycarbonate thermoplastic, ZYTEL™, a thermoplastic nylon, and other thermoplastic alloys. The type of window material employed may be dependent upon the operating environment of the door (i.e. thermal material for freezers, chemical resistant for laboratories, etc.) or the material used to manufacture the panel 104 of the traffic-door 100.

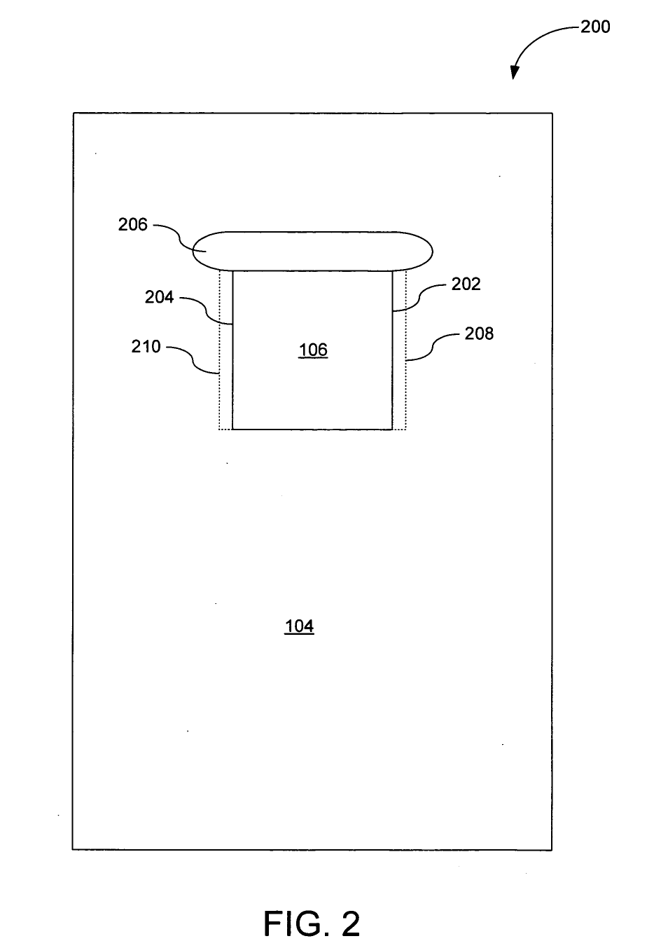

In FIG. 2, an illustration of a top view 200 of the widow 106 secured in panel 104 of the oscillating self-centering traffic-door 100 of FIG. 1 is shown. The window 106 is depicted as a square piece of transparent material that is larger than the side window openings 202 and 204 in the panel 104 except for an easement or access area 206 that may be partial milled or molded into panel 104. Channels 208 and 210 exist below either side of the window openings 202 and 204. The transparent material enters the channels 208 and 210 below the sides of the window openings 202 and 204, via the access area 206.

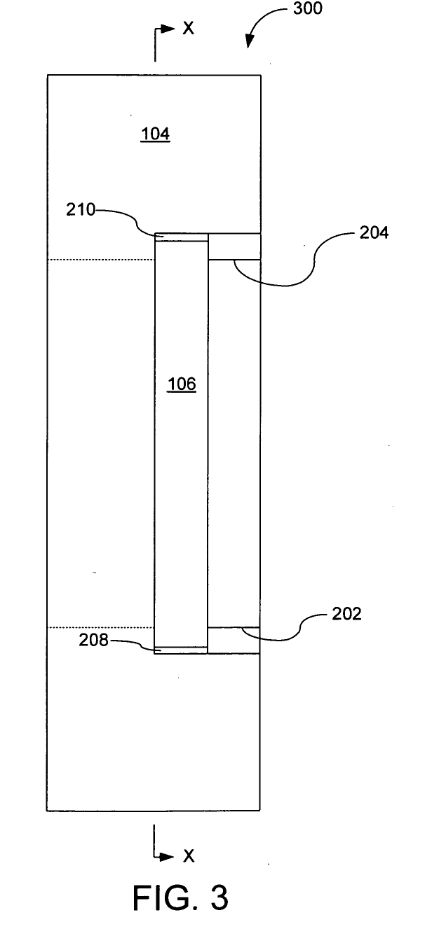

Turning to FIG. 3, an illustration of a cross sectional view 300 of the panel 104 of FIG. 1 along the x-axis through access area 206 of FIG. 2 is shown. The window 106 may be secured by the tight interlocking of the window 106 with channels 208 and 210. The channels 208 and 210 may be milled into the panel 104 by mortising or rabbeting with a milling machine that may or may not be computer controlled (i.e. hand-held routers or CNC routers to give but a few examples). In other implementations, the channel or channels may be made with a router, via molding, incorporating a channel fixture within the panel 104 during manufacturing, or mounting a channel fixture into a cutout area in the panel 104. The greatest cost savings may be achieved by use of a milling machine to cut the channels and access area into a solid or semi-solid panel. In other implementations, a plurality of sheets-may make up layers of a panel and when the sheets are combined the form a cutout for a window along with the channel or channels.

In addition to the side channels, in other implementations, a channel may also be made at the bottom of the cutout area in the panel 104 for the window 106 to rest in. Either side of the window openings 202 and 204 may define the sides of the viewable window area for the window 106 in panel 104. In other implementations, multiple sets of channels may be present in the panel 104 that enable multiple windows placed within a panel 104, such as windows in a freezer door panel that may have air space between the windows. In yet another implementation, portions of a window may be placed into the channel or channels and may have a clip between the different portions

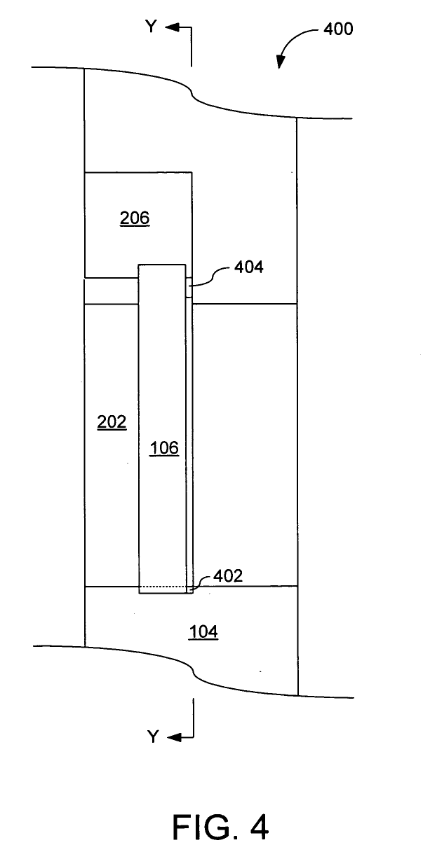

In FIG. 4, an illustration of a cross sectional view 400 of the panel 104 of FIG. 1 along the y-axis is shown. The window 106 is depicted as being installed, i.e. after being slide through the access area 206. A bottom channel 402 may be provided to assist with holding the widow 106 in the panel 104. The side of the window opening 202 is also visible in the illustration of FIG. 4. The window 106 may be held in place with friction, adhesives, or internally contained fasteners and less desirably with fasteners going through the panel that may be partially or fully recessed or incorporated into the panel 104. One approach to employing adhesive is to apply double sided adhesive tape or a bead of adhesive at the top of where the window 106 will rest when inserted at an inner portion of the open channel as shown at 404 of FIG. 4. Examples of types of adhesives that may be employed to aid in securing the window include; epoxies, acrylics, urethanes, cyanorcrylates, silicones, neoprenes, and resorcinols. The choice of adhesive may be partially or fully dictated by the type of material used in the window 106 and the panel 104.

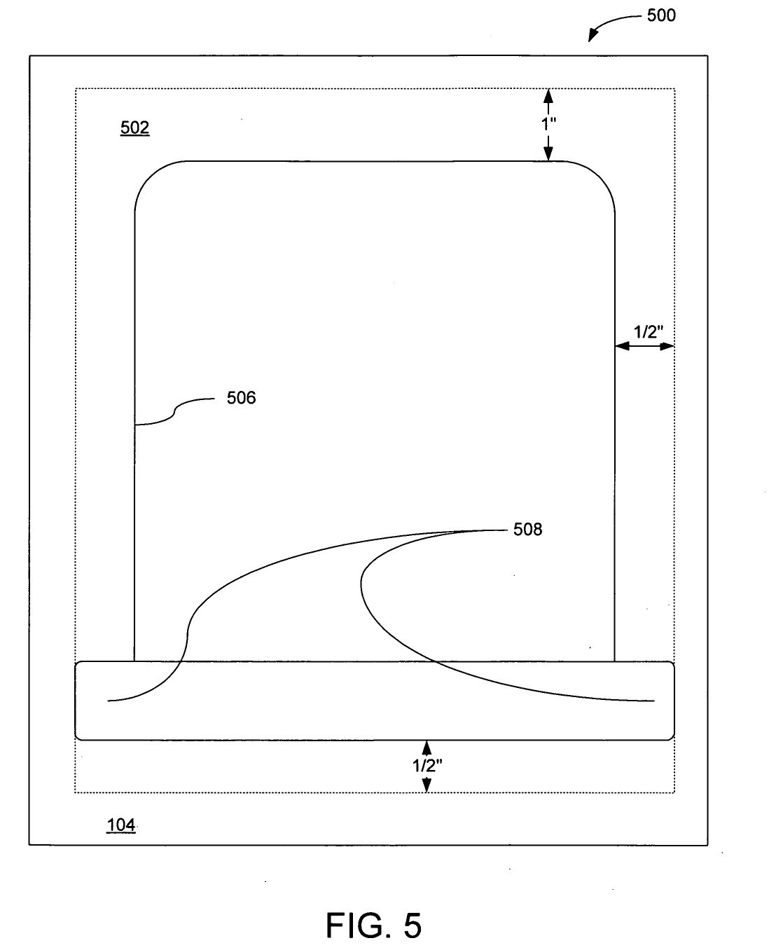

In FIG. 5, an illustration 500 of the approach to securing a window 106 in the panel 104 of FIG. 1 with channels 502 and 504 (or mortises) formed around the perimeter of the opening of the window 106 is shown. In another approach, a continuous channel or mortise may be cut into the machine or molded edge of a vacant window of a panel to enable a window to be inserted into the opening without the need for a gasket. The cutout 506 is made to the panel 104 such that the access area 508 of the cutout extends past the parameter of the majority of the cutout in the current example. The size of the access area may be dependent upon the size of window that will be slid into the channel or channels. The cutout is a complete cutout that goes through the panel, i.e. through the door. Two channels 502 and 504 are shown in FIG. 5, but in other implementations a different number of channels may be employed. Channel 502 is shown as extending a half inch beyond the cutout and even with the cutout of the access area 508 and may be one inch above the top of the cutout 506. This extra half-inch of space enables the window to be pushed up into the door before dropping down into channel 504. Channel 504 may be a half-inch deep at the bottom of the cutout 506 below the access area 508.

To assemble the window-into the panel, the window is slide through the access area up and into the one-inch channel and dropped back into the bottom half-inch channel and locked into position with adhesive cartridge applied at the top of the cutout 506. The tight interlocking of the channel and window eliminates the need for a gasket to be used around the window. In other implementations, the adhesive may be applied at the side or the bottom of the channel. In yet other implementations, the adhesive may be applied in all channels of the panel.

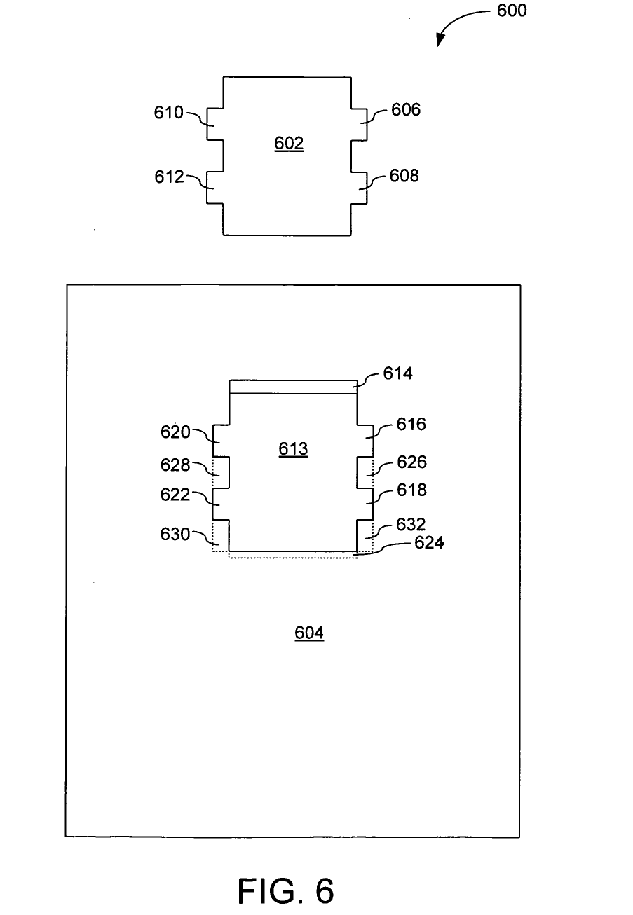

Turning to FIG. 6, an illustration 600 of another approach to securing a window 602 in a panel 604 of a traffic-door without gasketing is shown. The window 602 has a plurality of protrusions 606, 608, 610 and 612 that are used to hold the window in place within the panel 604. The window is placed in an opening 613 formed by the panel 604. The opening has an access area 614 that is not cut through the panel 604. The window 602 is set into the opening 613 and slide down into place, such that the bottom of the window rest in the bottom channel 624 and the protrusions 616, 618, 620, and 622 of the panel hold the protrusions 606, 608, 610, and 612 of the window 602 securely in place via channels 626, 628, 630, and 632. It should be noted that the channels 626, 628, 630 and 632 do not have to be the full length of the protrusions; rather they only have to be long enough to secure the protrusions 606, 608, 610 and 612 of the window. An adhesive may be used to hold the window 602 securely, once placed into the panel 604. The adhesive may be placed in the bottom channel 624, in the access area 614, in the protrusions 616, 618. 620, and 622, or any combination of the previous locations. In this implementation, the window 602 may be rigid and non-flexing. In other implementations, mechanical fasteners that do not protrude from the panel may be employed in addition to or in place of adhesive.

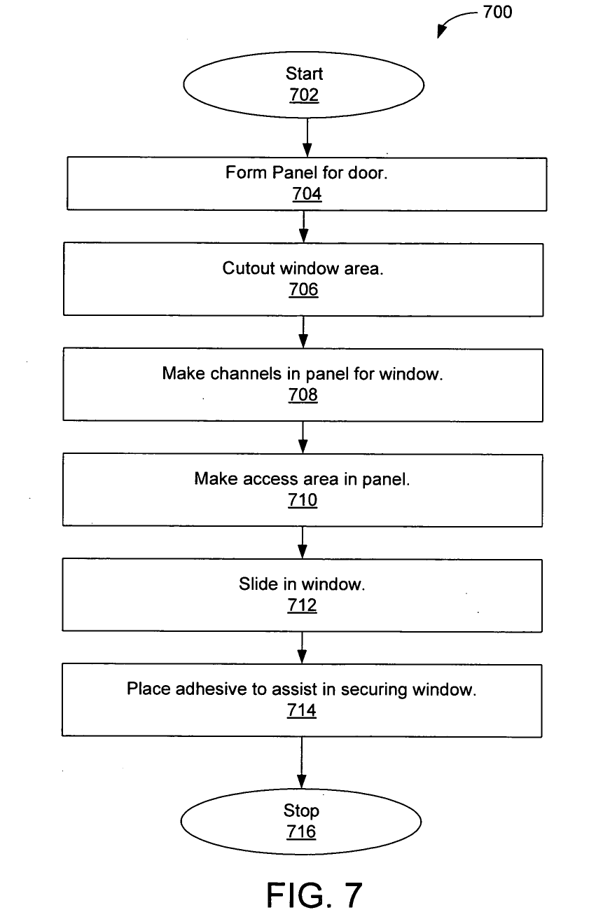

In FIG. 7, a flow diagram 700 of the steps for securing a window 106 in a panel 104 of the self-centering traffic-door of FIG. 1 is depicted. The flow diagram 700 starts 702 with the panel being formed for the door 704. The approach employed to form the panel 104 is dependent upon the type of materials being used (i.e. wood door is cut, plastic door is molded, metal is cast or welded) 704. Once the panel 104 is formed, cutting away material in the panel 104 in step 706 creates a window area. Channels 208 and 210 may then be cut into the sides and bottom of the window area of the panel 502 in step 708. An access area 206 may then be made in the panel 710 by milling part way through the panel 104. The window may then be slid into the channels 208 and 210 in step 712 and adhesive applied to a portion of the access area 206 in step 714. Once the adhesive is set, the installation of the window is complete 716. In other implementations, a step of adding mechanical fasteners may be used in addition to or in place of adhesive.

The foregoing description of an implementation has been presented for purposes of illustration and description. The descriptions have been of door panels, but are applicable to any type of panel that may have a window. It is not exhaustive and does not limit the claimed inventions to the precise form disclosed. Modifications and variations are possible in light of the above description or may be acquired from practicing the invention, such as rotating where the channels are located and where the access area is located. The claims and their equivalents define the scope of the invention.

What is claimed is:

1. A system for securing windows, comprising:
a window; and
a panel with an edge that defines a cutout for the window, where the edge has at least one channel located in the panel that secures the window.

2. The system of claim 1, where the at least one channel is formed by cutting the panel.

3. The system of claim 1, where the at least one channel is formed when the panel is molded.

4. The system of claim 1, where the window is a thermoplastic alloy.

5. The system of claim 4 where the window is a thermoplastic polyester.

6. The system of claim 1, where the window is further secured to the panel with an adhesive.

7. The system of claim 6, where the adhesive is applied in the at least one channel.

8. The system of claim 1, where the window is further secured by at least one fastener.

9. The system of claim 1, where the at least one channel defined by a plurality of layers that make up the panel.

10. The system of claim 1, where the edge of the cutout also defines an access area for the window.

11. The system of claim 1, where the edge that defines the access area is wider than the window and the rest of the edge is not as wide as the window.

12. A method to secure a window in a panel, comprising:
creating a cutout window area in a panel that is defined by an edge;
forming at least one channel in the edge; and
sliding the window into the at least one channel.

13. The method of claim 12, further includes placing adhesive between the window and the panel.

14. The method of claim 13, where placing adhesive further includes placing adhesive in the at least one channel.

15. The method of claim 12, where the step of creating further includes the step of routing the at least one channel into the panel.

16. The method of claim 12, where creating further includes the step of forming an access area in the window cutout area that is defined by the edge.

17. The method of claim 12, further includes creating a second channel opposite the at least one channel.

18. The method of claim 12, where forming at least one channel, further includes a plurality of sheets that are combined to form the panel and the at least one channel.

19. The method of claim 12, further includes securing the window in the at least one channel with at least one fastener.

20. A panel, comprising:
a window; and
an at least one opening having at least one channel that secures the window without mechanical means.

21. The panel of claim 20, where the window has more than one window portion.

22. The panel of claim 21, further includes a clip between the more than one window portions.

23. The panel of claim 20, where a second channel secures a second window spaced apart from the window.
